(19) United States
(12) Patent Application Publication
(10) Pub. No.: US 2021/0331505 A1
(43) Pub. Date: Oct. 28, 2021

(54) SECURITY DEVICE FOR SECURITY DOCUMENTS

(71) Applicant: Canadian Bank Note Company, Limited, Ottawa (CA)

(72) Inventors: Thivaharan THURAILINGAM, Stittsville (CA); Keith A. GOW, Napean (CA)

(21) Appl. No.: 17/273,866

(22) PCT Filed: Aug. 29, 2019
(86) PCT No.: PCT/CA2019/051194

§ 371 Date: Mar. 5, 2021

(30) Foreign Application Priority Data
Sep. 7, 2018 (CA) 3,016,788

(51) Int. Cl. B41M 3/14; B42D 25/342; B42D 25/435; B41M 5/24

(52) U.S. Cl. CPC B41M 3/14; B42D 25/342; B42D 25/23; B41M 5/24; B42D 25/435

(57) ABSTRACT

A security device for security documents providing an angle-dependent Moiré effect. A security device for a security document and method for making the security device are provided. At least two interlaced laser engraved images forming an angle dependent parallax effect. First and second images are laser engraved at a substrate of the security document and the substrate comprises a non-laser-engravable layer between laser engravable layers.

### FIELD OF THE INVENTION

The invention relates generally to security documents such as identification documents and particularly to a security device for security documents, the security device comprising interlaced images producing an angle-dependent Moiré effect.

### BACKGROUND

Counterfeits in security documents are quite prevalent due to the demand of fake identification documents for various purposes including underage drinking, access to festivals with age restriction, and illegal activities such as financial frauds and travels.

The advancement in digital printing technologies in the new era poses a challenge. The resolution of off-the-shelf inkjet and dye sub printers, availability of papers and polymers that accept high-quality print, and access to all the materials and knowledge through smart phones make counterfeiters' work more efficient. This advancement in printing technologies and communication produces a challenging situation for the security printer.

To fight counterfeiters, security features that can be identified without the use of an aid is important, such a hologram, kinegram, optically variable ink, etc. However, low grade hologram and optically variable ink can be purchased online, which counterfeiters have easy access to. To fight modern counterfeiting, it is important to produce security devices having features that can only be synthesized by the manufacturing process that is used for card production. While this may not be a fool-proof method, it does serve as a challenge for counterfeits.

EP0353974A2 discloses the use of a parallax effect (angle dependent Moiré phenomenon) to obtain an optical system on a transparent/translucent film. The metallic image lines and screen (grid) interleaved lines are applied by chemical deposition, vacuum deposition, by printing with metallic ink or by demetallization by chemical and laser. The feature will be costly due to metallization and the need of necessary registration involved between two images. Personalization is difficult to achieve with this technique as the metallization is done is sheet/web form. The present invention only needs laser engraving and no additional layering of metals with high optical density necessary. Since the laser engraving is the last process, the personalization is possible.

U.S. Pat. No. 6,494,491B1 discloses a similar optical effect obtained using the printing of at least two image patterns at a separated distance from each other by means of a transparent layer of material. The feature changes from light to dark due to Moiré effect raised by the overlapping patterns. The overlapping patterns are printed simultaneously or on two different layers and laminated together. This technique would not allow for personalization of the feature.

In U.S. Pat. No. 4,766,026A, the parallax effect is obtained by laser engraving an image through a transparent layer. The polymer layers, which blacken at different intensity values, are used to achieve this feature. A disadvantage of this is that the synthetic material used will have different grey value due to varying laser sensitivity. A higher laser sensitivity means the darker the film. This will produce a card with different grey on either side. The cost of material with varying laser sensitivities is high and would add more cost to the security device. In the present invention, a similar laser receptive polycarbonate film with a non-laser receptive film in the middle is used to achieve the result. The non-laser receptive film will displace the adjacent pattern to its thickness and allows for the angle-dependent Moiré effect.

### SUMMARY

A security device for a security document comprising at least two interlaced laser engraved images forming an angle dependent parallax effect wherein each image is laser engraved at a substrate of the security document, the substrate comprising a non-laser-engravable layer between laser engravable layers.

The present invention makes use of an angle-dependent Moiré phenomenon to provide a security device for identification documents. Moiré patterns are made up of two dimensional images that result from the interference of two overlapping patterns. In the present invention, the overlapping patterns are laser engraved on identification documents, which would allow for personalization. By displacing two immediately adjacent patterns by tilt, the Moiré interference pattern also changes, leading to the known, changing light-dark image effect.

The laser engraved angle-dependent Moiré effect uses two interleaved images and three variations are described:

1. Angle-dependent Moiré effect in the transparent region by allowing the laser engraving on the face and back sides of the card with tight registration;
2. Angle-dependent Moiré effect in the opaque region by allowing the laser engraving at two different angles and with tight registration; and
3. Combined Moiré effect (1+2) in the transparent and opaque regions.

### BRIEF DESCRIPTION OF THE DRAWINGS

FIG. 1 illustrates the front of an identification document having two security devices in accordance with the invention.

FIG. 2 illustrates the back of the identification document of FIG. 1.

FIG. 3 illustrates an image of the security device of FIGS. 1 and 2 at a view angle.

FIG. 4 illustrates an image of the security device of FIGS. 1 and 2 at a different view angle.

FIG. 5 illustrates a security document card construction necessary for obtaining laser engraved Moiré effect.

FIG. 6 illustrates two images used to obtain laser engraved Moiré effect in a transparent region of a security document.

FIG. 7 illustrates a security device in the transparent region of a laminated card.

FIG. 8 illustrates a security document card construction and the laser engraving specification of the Moiré effect in an opaque region of the card.

FIG. 9 illustrates a segmentation of an image used to obtain laser engraved strata in an opaque region of the card.

FIG. 10 illustrates a security document with laser engraved Moiré effect within an opaque region of the document.

FIG. 11 illustrates a card construction and the laser engraving of the combined strata feature.

FIG. 12 illustrates an angle-dependent Moiré effect on both a transparent and opaque region of a security document.

FIG. 13 illustrates a security document with laser-engraved Moiré effect within transparent and opaque regions of the document.

FIG. 14 illustrates the minimum necessary images to achieve an angle-dependent Moiré effect.

### DETAILED DESCRIPTION

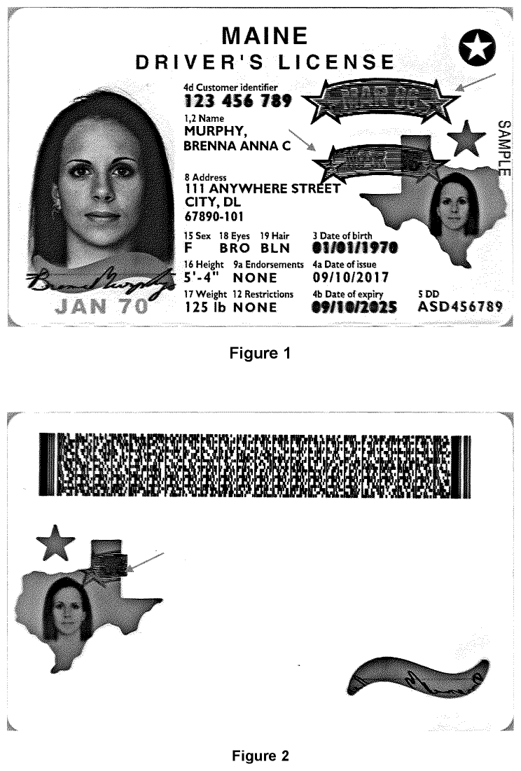

FIG. 1 of the drawings shows the front of an identification document having two security devices in accordance with the invention. A first security device producing a parallax effect is highlighted by an arrow marking at the top of the identification document has date of birth, MAR 86, laser engraved on the opaque region of the document. Another security device producing a parallax effect is highlighted by an arrow marking below the first security device overlapping a transparent region of the document. The “MAR” is laser engraved in the opaque region and the “86” is laser engraved in the transparent region.

FIG. 2 of the drawings shows the back of the identification document of FIG. 1. On the back of the document only the parallax effect located in the transparent region is visible. To achieve parallax effect in the transparent region, part of the image must be laser engraved at the back in the transparent region. Misregistration of the laser engraved image is highlighted by an arrow marking.

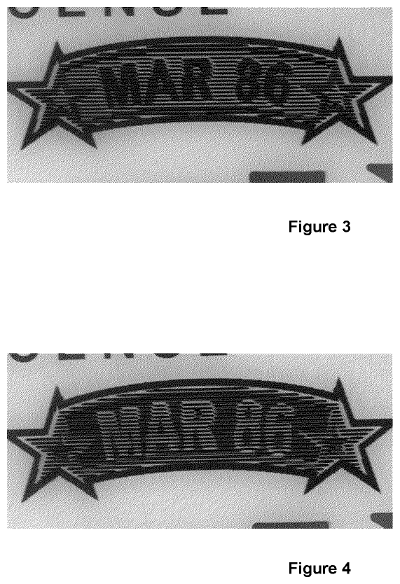

FIG. 3 is an image of the security device of FIGS. 1 and 2 illustrating the parallax effect of the security device in the opaque region, capturing the parallax effect at higher magnification. At about a +20 degree view angle, the text “MAR 86” appears darker compare to the background. This happens due to displacing two immediately adjacent patterns by tilt.

FIG. 4 is an image of the security device of FIGS. 1 and 2 illustrating the parallax effect of the security device in the opaque region, capturing the parallax effect at higher magnification. At about a −20 degree view angle the text “MAR 86” appears lighter compare to the background. This again happens due to displacing two immediately adjacent patterns by tilt.

### 1. Angle Dependent Moiré Effect in a Transparent Region

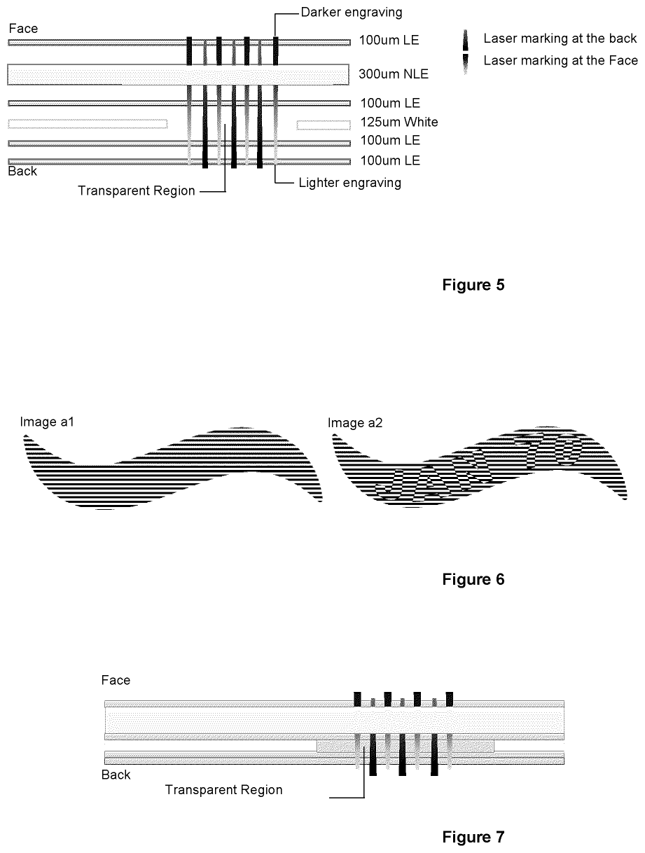

FIG. 5 illustrates the card construction of a security document for producing the laser engraved Moiré effect. Note, a 300 um non-laser engravable layer is used between the laser engravable layers to achieve the effect.

To achieve the security device in the transparent region, the card construction must be made with similar specifications as shown in FIG. 5. Two interlaced images, that is images a1 and a2 as shown in FIG. 6, must be laser engraved; one at the face side of the document and other at the back side; over the transparent region. Tight registration of these two images are essential. During laser engraving at the face side of the document, the energy of the beam will be high at the surface of the card leading to darker marking. As the laser beam moves down the card, energy will be absorbed, and the intensity will decrease. This leads to lighter laser engraving further down in the card (shown in faded line in FIG. 5). A similar process happens during laser engraving of the second image (image a2) at the back of the card. In both cases of laser engraving, the non-laser engravable layer will not get marked. The darker image of “image a1” at the face side and darker image of “image a2” at the backside will be separated by the thickness of the non-laser engravable layer as shown in FIG. 5. This separation allows for angle-dependent Moiré effect and leads to the light-dark image effect.

FIG. 6 illustrates two images which are used to obtain laser engraved Moiré effect in the transparent region. Image a1 is a screen image with a series of parallel lines. Image a2 contains a series of parallel lines, which carries phase shifted lines with personal data.

As shown in FIG. 6, images with parallel lines were investigated for proof of concept. It is also possible to use dot patterns, bowtie patterns, or dash lines to achieve similar/complex results. Image a2 only carries personal data. It is possible to embed data in both images to achieve complex and difficult counterfeit security devices.

FIG. 7 illustrates a security document with a security device providing a laser engraved Moiré effect in the transparent-window region. Note there is no laser engraving in the non-laser engravable layer.

### 2. Angle Dependent Moiré Effect in an Opaque Region

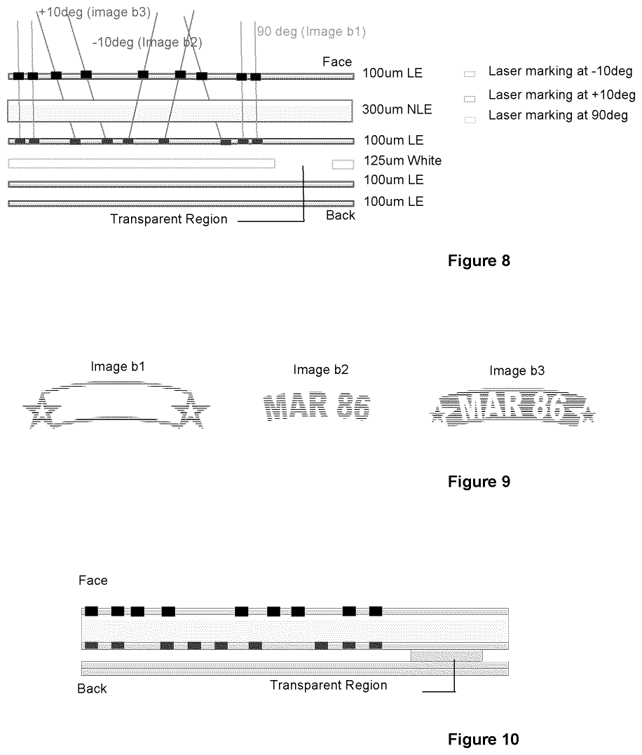

FIG. 8 illustrates a security document card construction and the laser engraving specification of the Moiré effect in the opaque region.

FIG. 9 is a segmentation of an image used to obtain laser engraved strata in the opaque region. Images b1, b2 and b3 are shown in FIG. 9 and marked at three different angles; 90 deg, −10 deg, and +10 deg. Image b1 is a reference image, engraved at 90 deg. Images b2 and b3 were laser engraved at an angle +10 and −10 deg, respectively. These angles could be altered to obtain desired specific results. In the tested condition, images b2 and b3 carry the personal data.

The angle-dependent Moiré effect is achieved differently in the opaque region compared to transparent region. At least two images are necessary (images b2 and b3 as shown in FIG. 9) to obtain the effect in the opaque region. A third image can be added to enhance the visual appearance of the effect. During laser engraving, a reference image was laser engraved at 90 deg as shown in FIG. 8. Preferably a solid image should be used, but an image made of lines were tested. The image b2 and b3 will carry the data as shown in FIG. 9. To produce the device, image b2 is laser engraved at −10 degrees and image b3 is engraved at +10 degrees.

During the laser marking of image b2 at −10 degrees, the laser is engraved at the surface layer. The marking will be dark. As the laser beam goes down to the next laser-engravable layer; beside the opaque layer, there will be a slight shift where the marking will be as shown in FIG. 8. The beam intensity will drop as well due to absorption at the surface layer.

The laser engravable layer that sits beside the opaque (white) layer gets a darker marking with a lower energy laser beam. During laser engraving, the sheet adjacent to the opaque layer gets exposed to the laser beam twice as the beam reflects off the white. This double exposure to the laser beam would yield enough contrast necessary for the Moiré effect. A similar process happens during the marking of image b3 at +10 degrees. The lines on image b1 that is marked at 90 degrees will get marked at the same location without offset.

FIG. 10 illustrates a security document with laser engraved Moiré effect within the opaque region.

Since both images b2 and b3 are laser engraved at two different angles, the offset created at the bottom laser engravable layer would yield an angle-dependent parallax effect with the presence of a non-layer engravable layer in the middle.

### 3. Combined Angle-Dependent Moiré Effect in Transparent and Opaque Regions

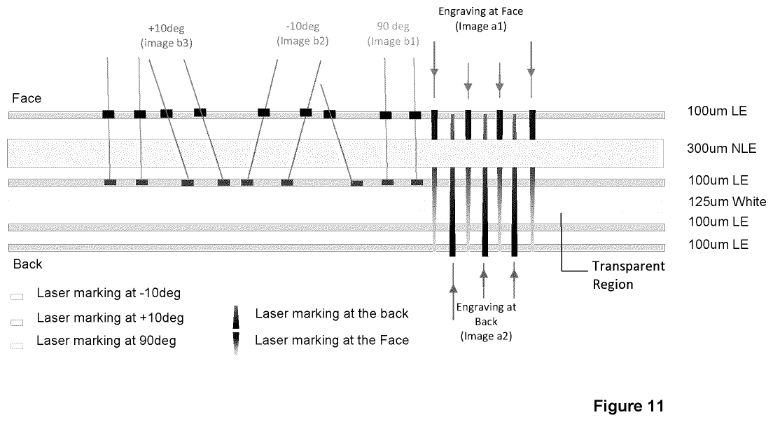

FIG. 11 illustrates the card construction and the laser engraving of the combined strata feature wherein angle-dependent Moiré effect is obtained on both transparent and opaque regions. The combination of both is possible with slight modifications to the images and process.

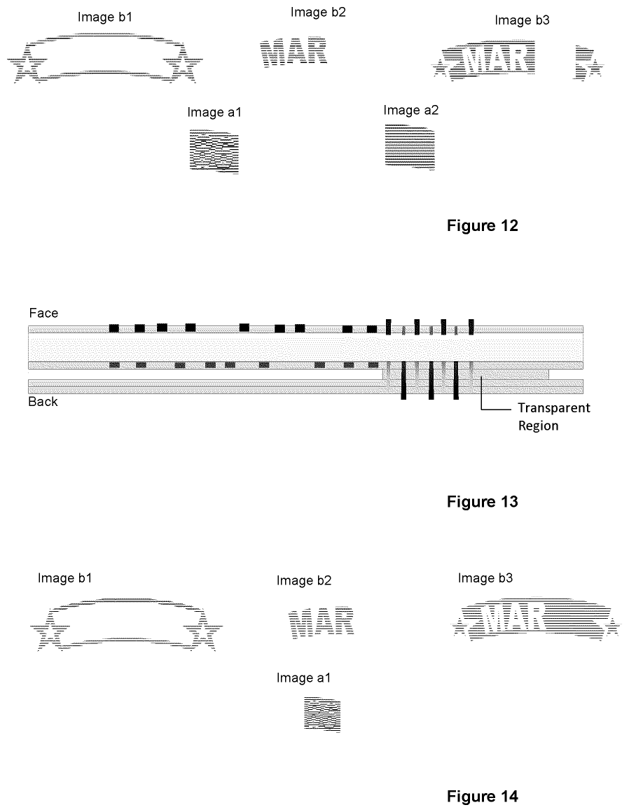

FIG. 12 illustrates an image split into 5 segments and laser engraved on both transparent and opaque regions to achieve combined strata. As shown in FIG. 12, five images were used to achieve the feature. Images b2 and b3 are used to obtain the Moiré effect on the opaque region. Images a1 and a2 are used for Moiré effect in the transparent region. One image for both opaque and transparent regions is shown in image b1. As shown in FIG. 11, images b1, b2 and b3 are laser engraved on an opaque region as discussed in section “Angle-dependent Moiré effect in an opaque region”. Image a1 and b1 are processed in a similar fashion as discussed in section “Angle-dependent Moiré effect in a transparent region”. The registration of all five images were maintained to achieve the effect.

FIG. 13 illustrates a security document with laser-engraved Moiré effect within the transparent and opaque regions. Note the laser engraving shown in three different colors, green, blue and red, in the opaque region are completed at angle 90 degrees, −10 degrees, and +10 degrees. The laser engraving in the transparent region is done at the front and back, in blue and red respectively.

Five images were used to achieve the angle-dependent Moiré effect in the opaque and transparent regions. The number of images can be reduced to 3 images as shown (image b2, b3 and a1) and the necessary optical effect can still be obtained.

FIG. 14 illustrates the minimum necessary images to achieve angle-dependent Moiré effect.

What is claimed is:

1. A security device for a security document comprising at least two interlaced laser engraved images forming an angle dependent parallax effect wherein a first image and a second image is laser engraved at a surface of a substrate of the security document, and the substrate comprises a non-laser-engravable layer between laser engravable layers.

2. A method for making a security device for a security document comprising at least two interlaced laser engraved images forming an angle dependent parallax effect wherein first image and second images are laser engraved on a substrate of the security document and the substrate comprises a non-laser-engravable layer between laser engravable layers.

3. A security document comprising a security device according to claim 1.

4. A security document comprising a security device made by the method of claim 2.
